(19) United States
(12) Patent Application Publication
(10) Pub. No.: US 2018/0305096 A1
(43) Pub. Date: Oct. 25, 2018

(54) GLASS PLATE INTERLEAVING PAPER

(71) Applicant: OJI HOLDINGS CORPORATION, Tokyo (JP)

(72) Inventors: Koichi Hagihara, Tokyo (JP); Kazuhiko Shirai, Tokyo (JP)

(21) Appl. No.: 15/768,516

(22) PCT Filed: Aug. 12, 2016
(86) PCT No.: PCT/JP2016/003735

§ 371 Date: Apr. 13, 2018

(30) Foreign Application Priority Data
Oct. 23, 2015 (JP) 2015-209225

(51) Int. Cl. B65D 57/00; B65D 85/48; C03B 40/033; D21H 19/12

(52) U.S. Cl. CPC B65D 57/00; B65D 85/48; D21H 21/16; D21H 19/12; C03B 40/033

(57) ABSTRACT

Provided is glass plate interleaving paper by which the contamination due to transfer of foreign substances from the interleaving paper to the surface of the glass plate is decreased. This interleaving paper is prepared using paper containing cellulose pulp as a main component as a base material and imparting a water-soluble resin exhibiting high solubility in water to the base material.

### TECHNICAL FIELD

The present invention relates to interleaving paper to be inserted between a plurality of glass plates, and particularly, to interleaving paper for glass plate which is less likely to cause contamination of the surface of a glass substrate through the adhesion of foreign substances such as sticky natural resin derived from wood contained in the pulp, paper powder, dust, and an organopolysiloxane compound in the distribution process and manufacturing step in which a plurality of glass substrates for a flat panel display such as a liquid crystal panel display or a plasma panel display are stacked, stored, and transported.

### BACKGROUND ART

In recent years, the quality requirement for glass plate interleaving paper has become severer as glass has been utilized in a variety of applications. For example, in a glass substrate to be used in a flat panel display such as a liquid crystal display or a plasma display, the surface of the glass substrate is required to exhibit clarity to a certain extent since a film of an electronic member or the like is formed on the surface of the glass substrate.

The contact pressure between the interleaving paper and the glass substrate has increased and the probability that foreign substances from the interleaving paper adhere to the glass substrate has increased as the glass substrates are transported by being superimposed as many as possible for the purpose of increasing the transportation efficiency along with the recent increase in size and mass production of glass substrates. Meanwhile, the surface of glass substrate is required to exhibit higher clarity as the definition of flat panel display has increased. By such circumstances, the quality requirement level for interleaving paper is increasing. Specifically, it is required that foreign substances such as a sticky natural resin derived from wood contained in the interleaving paper, paper powder, fine dust, and substances to be mixed in the step of manufacturing raw material pulp of interleaving paper or the step of making interleaving paper from the raw pulp do not adhere to the surface of glass substrate as much as possible during storage or in the transportation process.

PTL 1 discloses a configuration in which a water-soluble resin is coated on both surfaces of dust-free paper prepared by impregnating 100 parts by weight of natural pulp with from 5 to 40 parts by weight of a resin binder and drying the impregnated natural pulp as a configuration of glass plate interleaving paper for preventing generation of so-called paper sag (a phenomenon that water repellency is developed on the glass surface by the contact between the interleaving paper and the glass, foreign substances adhere, or haze occurs) on the glass surface.

PTL 2 proposes glass plate interleaving paper prepared by impregnating base paper formed of natural pulp with a resin emulsion containing a crosslinkable component for the purpose of preventing contamination of the glass plate.

### CITATION LIST

### Patent Literature

PTL 1: Japanese Patent Laid-Open No. H09-170198(1997)

PTL 2: Japanese Patent Laid-Open No. 2006-144133

### SUMMARY OF INVENTION

### Technical Problem

However, in the case of using the glass plate interleaving paper of PTL 1, there is a trouble that the resin binder adheres to (contaminates) the glass plate as the resin binder component is eluted from the pulp (paper powder) derived from the interleaving paper adhered to the glass plate or the water-soluble resin is lost or eluted on the pulp surface constituting the interleaving paper so that a resin binder layer is exposed and comes into direct contact with the glass plate in the step of cleaning the glass plate before shipment and the like. There has been a problem that it is difficult to wash away the glass surface contaminated with the resin binder (particularly hydrophobic one) only by chemical cleaning, brushing cleaning, or ultrasonic cleaning. Moreover, in order to sufficiently cover the layer containing a resin binder, it is required to coat a large amount of a water-soluble resin, and in this case, it is required to strengthen the cleaning since the amount of water-soluble resin adhered to the glass plate increases.

In addition, in the case of using the glass plate paper of PTL 2, there is a high risk that the emulsifier and various kinds of additives used in the process of manufacturing the resin emulsion to be contained in the interleaving paper adhere to the glass surface.

Here, a glass plate, particularly a glass substrate to be used in a flat panel display, undergoes a step of cleaning the glass surface using a medium mainly composed of water before shipment and a step of mounting electronic components and the like. In this step, foreign substances adhered to the surface of the glass substrate are almost washed away, but adhesive foreign substances and substances exhibiting high affinity for glass are not easily removed to adhere to the glass surface even after cleaning. Particularly, an organopolysiloxane compound typified by polydimethylsiloxane exhibits high affinity for glass and it is difficult to remove the organopolysiloxane compound once it adheres to the glass surface, thus transfer of the organopolysiloxane compound to the glass surface is contraindicated, and it is a technical problem to decrease this to what extent.

An object of the present invention is to provide glass plate paper by which the contamination due to transfer of foreign substances from the glass plate interleaving paper to glass is decreased in the distribution process and manufacturing step in which a plurality of glass plates are stacked, stored, and transported.

### Solution to Problem

The present invention includes the following inventions.

(1) Glass plate interleaving paper prepared by imparting a water-soluble resin to a paper base material containing cellulose pulp as a main component in an amount of 0.1 g/m² or more in terms of solids, in which in the case where a film is formed of the water-soluble resin and immersed in water at 40° C. for 1 hour, the water-soluble resin has a solubility of a film of 50% or more based on a mass of the film before being immersed and a content of an organopolysiloxane compound to be contained in 1 kg of air-dried mass of the glass plate interleaving paper is 5 mg or less.

(2) The glass plate interleaving paper according to (1), in which an amount of the water-soluble resin imparted to the paper base material is 0.2 g/m² or more and 10 g/m² or less in terms of solids.

(3) The glass plate interleaving paper according to (1) or (2), in which in the case where a film is formed of the water-soluble resin and immersed in water at 40° C. for 1 hour, the water-soluble resin has a solubility of a film of 90% or more based on a mass of the film before being immersed.

(4) The glass plate paper according to any one of (1) to (3), in which the water-soluble resin is at least one kind or a mixture of two or more kinds selected from the group consisting of a polyvinyl alcohol-based resin, a polyacrylamide-based resin, starch, and any modified product thereof.

(5) The glass plate interleaving paper according to (1) or (2), in which the water-soluble resin is polyvinyl alcohol having a saponification degree of from 70 to 97 mol %.

### Advantageous Effects of Invention

The glass plate interleaving paper of the present invention can decrease the contamination due to transfer of foreign substances from the interleaving paper to the surface of the glass plate when being used in a distribution process in which a plurality of glass plates, particularly glass substrates for a flat panel display, are stacked, stored, and transported.

### DESCRIPTION OF EMBODIMENTS

Hereinafter, the present invention will be described in detail. The following embodiments are for illustrative purposes, and the present invention is not to be construed as being limited to these embodiments.

<Glass Plate Interleaving Paper>

As a result of intensive investigations to solve the above-mentioned problems, the present inventors have found out that it is possible to provide glass plate interleaving paper from which the generation of paper powder and dust is suppressed by imparting an appropriate amount of a water-soluble resin to a paper base material containing cellulose pulp as a main component. In addition, it has been found out that by selecting a water-soluble resin having a high solubility in water after being formed into a film as a water-soluble resin to be imparted, it is possible to easily wash away and remove the water-soluble resin or the foreign substances adhered to or contained in the water-soluble resin in the cleaning step even when the water-soluble resin adheres to the glass surface by any chance. Moreover, the present invention has been completed by paying attention to the fact that it is possible to diminish the risk of transfer of an organopolysiloxane compound to the glass surface by suppressing the content of the organopolysiloxane compound to be generally used in a defoaming agent and the like in the glass plate interleaving paper low.

The glass plate interleaving paper of the present invention is a glass plate interleaving paper prepared by imparting a water-soluble resin to a paper base material containing pulp as a main component in an amount of 0.1 g/m² or more in terms of solids, in which in the case where a film is formed of the water-soluble resin and immersed in water at 40° C. for 1 hour, the water-soluble resin has a solubility of a film of 50% or more based on a mass of the film before being immersed and a content of an organopolysiloxane compound to be contained in 1 kg of air-dried mass of the glass plate interleaving paper is 5 mg or less.

<Paper Base Material>

The glass plate interleaving paper of the present invention contains a paper base material containing cellulose pulp as a main component. In the present specification, to “contain cellulose pulp as a main component” means to contain cellulose pulp in an amount of more than 50 mass % based on the entire mass (absolute dry) of the paper base material. The paper base material can contain components (hereinafter also referred to as “other components”) other than cellulose pulp as a component constituting the paper base material in an amount of less than 50 mass % based on the entire mass (absolute dry) of the paper base material. Other components include fibers other than cellulose pulp and papermaking internal additives to be generally used.

(Cellulose Pulp)

As the cellulose pulp in the paper base material of the glass plate interleaving paper of the present invention, various kinds of cellulose pulp may be used singly or in mixture of two or more kinds thereof. For example, it is possible to use pulp selected from chemical pulp such as kraft pulp (KP), sulfite pulp (SP), or soda pulp (AP); semi-chemical pulp such as semi-chemical pulp (SCP) or chemi-groundwood pulp (CGP); mechanical pulp such as groundwood pulp (GP), thermomechanical pulp (TMP, BCTMP), or refiner groundwood pulp (RGP); and non-wood fiber pulp using paper mulberry, paper birch, hemp, and kenaf as a raw material. In the case of wood pulp, the material to be used may be softwood or hardwood or a mixture thereof.

(Other Components)

The paper base material of the glass plate interleaving paper of the present invention can contain components (“other components”) other than the cellulose pulp. As other components, for example, various kinds of synthetic fibers can be included. For example, it is possible to use one kind of synthetic fiber or a mixture of two or more kinds of synthetic fibers selected from polypropylene (PP), polyethylene terephthalate (PET), polystyrene (PS), and the like.

In addition, as other components, it is also possible to add a papermaking internal additive to be generally used when making the paper base material to an extent to which the glass surface is not contaminated. Examples of such an internal additive may include various kinds of sizing agents, paper strengthening agents, filtered water retention improving agents, wet paper strengthening agents, bulking agents, inorganic or organic fillers, antistatic agents, foam inhibitors, and defoaming agents. However, an organopolysiloxane compound-based material should not be selected as any of these internal additives.

(Manufacture of Paper Base Material)

The means for manufacturing the paper base material of the glass plate interleaving paper of the present invention is not particularly limited, and the paper base material of the glass plate interleaving paper glass plate of the present invention can be made by selecting the papermaking conditions corresponding to each of various papermaking apparatuses. For purposes of illustration but not of limitation, the paper base material of the glass plate interleaving paper of the present invention can be made using a papermaking machine, such as a Fourdrinier former, a twin wire former, a cylinder former, or an inclined former, known to those skilled in the art. The layer configuration of the paper base material to be made may be a single layer or multiple layers.

<Water-Soluble Resin>

The glass plate interleaving paper of the present invention contains a water-soluble resin imparted to the paper base material in an amount of 0.1 g/m² or more in terms of solids. The water-soluble resin imparted to the paper base material is considered to cover at least a part of the components constituting the paper base material and to prevent the covered component from coming into direct contact with and adhering to the glass surface. Moreover, in the present invention, a specific resin, in the case where a film is formed of the water-soluble resin and immersed in water at 40° C. for 1 hour, which has a solubility of a film of 50% or more based on a mass of the film before being immersed is selected as the water-soluble resin. By selecting such a specific resin, it is considered that the covered component can be easily removed from the surface of the glass plate since this can be washed away together with the water-soluble resin in the cleaning step using water, for example, even if this once adheres to the glass surface in a case in which the covered component is a substance (for example, paper powder) which falls off from the glass interleaving paper.

(Kind of Water-Soluble Resin)

The water-soluble resin in the present invention is a water-soluble resin having a solubility of 50% or more based on the mass (absolute dry) of the film before being immersed, when being formed into a film and then immersed in water at 40° C. for 1 hour. The present object can be achieved when the solubility is 50% or more, but it is preferable that the solubility is higher, and the solubility is more preferably 90% or more.

The water-soluble resin of the present invention can be selected from various ones such as generally commercially available polyvinyl alcohol-based resins, polyacrylamide-based resins, polyvinyl pyrrolidone-based resins, starch and modified products thereof, and gelatin without being limited to synthetic and natural ones. Polyvinyl alcohol-based resins, polyacrylamide-based resins, starch and modified products thereof are preferable from the viewpoint of ease of handling and cost. Among these, a polyvinyl alcohol-based resin is preferably used for the present object since it is possible to freely impart solubility and other various properties to the polyvinyl alcohol-based resin by changing the molecular weight, saponification degree, and the degree of modification and a polyvinyl alcohol-based resin exhibits high film-forming property.

In order to achieve a high solubility, selection of the water-soluble resin is important. The saponification degree is an important factor particularly in the case of a polyvinyl alcohol-based resin. Polyvinyl alcohol is a synthetic resin having a rational formula (—CH₂CH(OH)—)ₙ, and the polyvinyl alcohol-based resin can be generally obtained by a method in which polyvinyl acetate obtained by polymerizing a vinyl acetate monomer is saponified and the like. The saponification degree of polyvinyl alcohol-based resin is an index indicating to what extent the acetate group of polyvinyl acetate is substituted with a hydroxyl group, and it is expressed as a percentage (unit: mol %) of the number of hydroxyl groups with respect to the total number of acetate groups and hydroxyl groups. There is a case in which the saponification degree may be said as complete saponification (saponification degree is close to approximately 100 mol %) or partial saponification in descending order of saponification degree. It is known that the saponification degree affects the water resistance of film and the like, and it is generally said that the viscosity of aqueous solution tends to decrease and the strength of film tends to weaken as the saponification degree decreases. In order to achieve the present object, it is possible to use polyvinyl alcohol-based resins having various saponification degrees which may be complete saponification or partial saponification, but a polyvinyl alcohol-based resin having a saponification degree of from 70 to 97 mol %, so-called partial saponification is preferably used.

Incidentally, there is a case in which a defoaming agent is added for the purpose of suppressing foaming of the aqueous solution or breaking the generated foam when an aqueous solution is prepared by dissolving a water-soluble resin in water and imparted to the paper base material. In the papermaking industry, generally a so-called silicone-based defoaming agent is preferably used as a defoaming agent, but when this is used, the risk of transfer of the organopolysiloxane compound to the glass surface increases. Hence, in the present invention, it is preferable to select a defoaming agent other than organopolysiloxane compound-based ones, for example, a higher alcohol-based compound, a compound having a polyether skeleton, or so-called non-silicone type one containing mineral oil as a main component.

(Means for Imparting Water-Soluble Resin)

The means for imparting the water-soluble resin to the paper base material is not particularly limited, and it is possible to manufacture the glass plate interleaving paper of the present invention by selecting the imparting conditions corresponding to each of the various imparting apparatuses. For purposes of illustration but not of limitation, means for imparting the water-soluble resin to the paper base material includes, for example, a bar coater, a blade coater, an air knife coater, a rod coater, a curtain coater, a two-roll size press, and a transfer roll coater (gate roll coater). The method of imparting the water-soluble resin to the paper base material may be any means, such as coating, immersion, or spraying, known to those skilled in the art as long as the water-soluble resin can be imparted to at least one surface of the paper base material.

(Amount of Water-Soluble Resin Imparted)

A desired effect can be obtained when the amount of the water-soluble resin imparted to the paper base material is 0.1 g/m² or more, but the imparted amount is preferably from 0.2 to 10 g/m² and more preferably from 0.3 to 4 g/m². Sufficient covering and a desired effect are not obtained when the imparted amount is less than 0.1 g/m². On the other hand, when the imparted amount exceeds 10 g/m², there is a tendency that the interleaving paper becomes hard and troubles in handling are caused although the effect of suppressing the transfer of foreign substances is obtained. In addition, the possibility that the water-soluble resin falls off from the paper base material and adheres to the surface of the glass plate increases when the amount of the water-soluble resin imparted to the paper base material is large. Incidentally, even in a case in which the fallen or eluted water-soluble resin adheres to the surface of the glass plate, it is possible to remove the adhered substances by subsequent washing with water more easily than in the prior art since a specific water-soluble resin having a high solubility is selectively used in the present invention.

<Specification of Glass Plate Interleaving Paper>

The glass plate interleaving paper of the present invention preferably has a basis weight of from 10 to 100 g/m², a thickness of from 25 to 250 μm, and a density of from 0.4 to 1.2 g/m³. The paper base material for having the specification is made so as to have suitable basis weight, thickness, and density ranges in consideration of those of the water-soluble resin to be imparted later. The glass plate interleaving paper of the present invention more preferably has a basis weight of from 35 to 80 g/m², a thickness of from 87 to 200 μm, and a density of from 0.4 to 1.2 g/m³. It is more preferable that the basis weight is lower since the mass at the time of transportation is lower, but it is not possible to impart sufficient cushioning property when the basis weight is too low. In addition, it is preferable that the basis weight is higher to a certain extent from the viewpoint of cushioning property, but it is not preferable that the basis weight is too high since the mass at the time of transportation is higher. The glass plate interleaving paper of the present invention preferably has a basis weight of 10 g/m² or more and 100 g/m² or less in consideration of the balance between cushioning property and ease of transportation.

(Organopolysiloxane Compound)

In the present invention, the content of the organopolysiloxane compound in the glass plate interleaving paper for is specified. An organopolysiloxane compound is also generally called a silicone and has a main skeleton in which a silicon atom and an oxygen atom are alternately and continuously bonded to each other and a structure in which an organic group composed of a carbon atom and a hydrogen atom is bonded to a silicon atom. Polydimethylsiloxane in which the organic group is a methyl group is general, but there are also compounds having a structure in which some of the methyl groups are substituted with various organic groups for the purpose of imparting a function. In general, an organopolysiloxane compound exhibits high affinity for glass, and it is difficult to remove the organopolysiloxane compound once it adheres to the glass surface. Hence, in the present invention, the content of the organopolysiloxane compound in the glass plate interleaving paper is specified.

It is more preferable that the content of the organopolysiloxane compound in the glass plate interleaving paper is lower, and it is possible to achieve the present object when the content is 5 mg or less per 1 kg of air-dried mass of the interleaving paper. Meanwhile, the frequency that the organopolysiloxane compound transfers from the interleaving paper to the glass surface increases and the proportion defective when processing the glass substrate increases when the content exceeds 5 mg.

The content of the organopolysiloxane compound can be measured using various analyzers such as a nuclear magnetic resonance spectrometer, a fluorescent X-ray apparatus, and a high performance liquid chromatography apparatus, but these are different in the analysis accuracy, convenience, and the like. In the present invention, the content of the organopolysiloxane compound is measured by nuclear magnetic resonance spectroscopy using polydimethylsiloxane as a standard as to be described later.

<Others>

In the present invention, it is preferable to remove foreign substances on the surface of the paper base material or interleaving paper using a dust removal device before or after the water-soluble resin is imparted. As an example of the dust removal device, for example, it is possible to use a magnetic brush cleaner, an electrostatic brush cleaner, a magnetic roller cleaner, a blade cleaner, a brush cleaner, a web cleaner, or the like. It is preferable to remove the dust on the surface of the glass substrate on the side in contact with the surface for circuit formation and it is more preferable to remove the dust on both surfaces thereof.

### EXAMPLES

Hereinafter, the present invention will be described in detail with reference to Examples, but the present invention is not limited by these. Incidentally, the numerical value indicating blending is a numerical value based on the mass of solids or active components. In addition, the paper made was treated in conformity with JIS P8111 and then subjected to measurement and evaluation tests unless otherwise particularly stated. The method of measuring the solubility of a film of a water-soluble resin, the method of evaluating the contamination property of the surface of a glass plate, and the method of measuring the content of an organopolysiloxane compound are as follows.

<Method of Measuring Solubility of Film of Water-Soluble Resin>

An aqueous solution of a water-soluble resin was put in a stainless steel vat, a polyethylene terephthalate sheet (A) was immersed therein, and the aqueous solution of a water-soluble resin was allowed to adhere to the polyethylene terephthalate sheet (A) in a range of from 3 to 10 g/m² in terms of solids. Subsequently, the polyethylene terephthalate sheet (A) to which the aqueous solution of a water-soluble resin adhered was dried at 120° C. for 1 hour, thereby obtaining a polyethylene terephthalate sheet (B) having a film of the water-soluble resin formed on its surface. From a polyethylene terephthalate sheet (C) obtained by immersing the polyethylene terephthalate sheet (B) thus obtained in distilled water at 40° C. for 1 hour and then drying the immersed sheet (B), the solubility of the film of a water-soluble resin was calculated using the following equation.

Solubility (%)=(mass of B−mass of C)×100/(mass of B−mass of A)

<Method of Evaluating Contamination Property of Surface of Glass Plate>

Two glass plates (7.5 cm×2.5 cm) for liquid crystal glass were prepared, stacked to sandwich one sheet of interleaving paper (8.5 cm×3.5 cm) therebetween, and placed flat. At this time, the contact surface of the glass plate with the interleaving paper was completely covered with the interleaving paper by disposing the glass plates and the interleaving paper such that the glass plates were positioned and the interleaving paper protruded from all sides of the superimposed glass plates in plan view from above. The stacked body thus obtained was left to stand for 4 days in an environment having a temperature of 23° C. and a humidity of 50% in a state of applying a load of 4 kg/cm² to the stacked body from above using a pressing jig.

Next, the number of foreign substances (particles) which had a size of 1 μm or larger and adhered to the surface of the glass plate in contact with the felt surface side of the interleaving paper was measured using an optical microscope, and the contamination property of the surface of the glass plate was determined according to the following determination criteria.

Incidentally, the paper base material constituting the interleaving paper has a surface (wire surface) on the side in contact with the papermaking wire at the time of papermaking and a surface (felt surface) on the side opposite thereto. In the present specification, the felt surface side of the interleaving paper refers to the side on which the surface of the paper base material constituting the interleaving paper is the felt surface.

Next, the surface of the glass plate was washed with water using an ultrasonic cleaning apparatus to which pure water and a detergent were added, followed by rinsing and drying, and subjected to the determination of contamination property in the same manner.

[Determination Criteria for Contamination Property]

⊚: Not contaminated (the number of foreign substances (particles) adhered on the glass surface is 2 particles/cm² or fewer)

◯: Partially contaminated but practically no problem (the number of foreign substances (particles) adhered on the glass surface is from 3 particles/cm² to 6 particles/cm²)

X: Contaminated (the number of foreign substances (particles) adhered on the glass surface is 7 particles/cm² or more) or cloudiness such as an oil film is observed on the glass surface)

<Method of Measuring Content of Organopolysiloxane Compound>

In a Soxhlet extractor, 100 g of interleaving paper was put and heated under reflux for 4 hours using n-hexane as an extraction solvent. The extract was concentrated and dried to obtain a solid using a rotary evaporator, and the residue was dissolved in 1 mL of deuterated chloroform. This solution was subjected to the measurement of the peak intensity (area) of a hydrogen atom bonded to a carbon atom adjacent to a silicon atom using a nuclear magnetic resonance spectrometer. The content of the organopolysiloxane compound was calculated based on the calibration curve created through separate measurement using polydimethylsiloxane as a standard.

### Example 1

A paper base material was made by making commercial pulp slurry NBKP 100% into paper using a Fourdrinier multi-cylinder paper machine, and an aqueous solution of polyvinyl alcohol (EXCEVAL (registered trademark) RS-2817 SB (saponification degree: 96.5 mol %) manufactured by KURARAY CO., LTD.) was coated on both surfaces of the paper base material thus obtained using a size press machine so as to be 1 g/m² per one surface in terms of solids (absolute dry mass) and dried, thereby obtaining glass plate interleaving paper having a basis weight of 45 g/m².

### Example 2

Glass plate interleaving paper was obtained in the same manner as in Example 1 except that a polyacrylamide resin (Polymerset (registered trademark) 512 manufactured by ARAKAWA CHEMICAL INDUSTRIES, LTD.) was used instead of polyvinyl alcohol (EXCEVAL (registered trademark) RS-2817 SB manufactured by KURARAY CO., LTD.) in Example 1.

### Example 3

Glass plate interleaving paper was obtained in the same manner as in Example 1 except that oxidized starch (Oji Ace A manufactured by Oji Cornstarch Co., Ltd.) was used instead of polyvinyl alcohol (EXCEVAL (registered trademark) RS-2817 SB manufactured by KURARAY CO., LTD.) in Example 1.

### Example 4

Glass plate interleaving paper was obtained in the same manner as in Example 1 except that one prepared by adding a defoaming agent (SN-DEFOAMER 395 manufactured by SAN NOPCO LIMITED) containing a polyether-based compound as a main component to an aqueous solution of polyvinyl alcohol (Kuraray Poval PVA 217 (saponification degree: 88.0 mol %) manufactured by KURARAY CO., LTD.) was used instead of an aqueous solution of polyvinyl alcohol (EXCEVAL (registered trademark) RS-2817 SB manufactured by KURARAY CO., LTD.) in Example 1.

### Example 5

Glass plate interleaving paper was obtained in the same manner as in Example 1 except that an aqueous solution of polyvinyl alcohol was coated so as to be 0.5 g/m² instead of 1 g/m² per one surface in terms of solids in Example 1.

### Example 6

Glass plate interleaving paper was obtained in the same manner as in Example 1 except that a mixed aqueous solution (proportion of solids, EXCEVAL (registered trademark) RS-2817 SB/Polymerset (registered trademark) 512=50%/50%) of polyvinyl alcohol (EXCEVAL (registered trademark) RS-2817 SB manufactured by KURARAY CO., LTD.) and a polyacrylamide resin (Polymerset (registered trademark) 512 manufactured by ARAKAWA CHEMICAL INDUSTRIES, LTD.) was used instead of an aqueous solution of polyvinyl alcohol (EXCEVAL (registered trademark) RS-2817 SB manufactured by KURARAY CO., LTD.) in Example 1.

### Example 7

Glass plate interleaving paper was obtained in the same manner as in Example 1 except that polyvinyl alcohol (Kuraray Poval PVA 117H (saponification degree: 99.3 mol %) manufactured by KURARAY CO., LTD.) was used instead of polyvinyl alcohol (EXCEVAL (registered trademark) RS-2817 SB manufactured by KURARAY CO., LTD.) in Example 1.

### Comparative Example 1

Glass plate interleaving paper was obtained in the same manner as in Example 1 except that coating of an aqueous solution of polyvinyl alcohol (EXCEVAL (registered trademark) RS-2817 SB manufactured by KURARAY CO., LTD.) was not conducted in Example 1. In other words, an aqueous solution of a water-soluble resin was not coated on the paper base material in Comparative Example 1.

### Comparative Example 2

Glass plate interleaving paper was obtained in the same manner as in Example 1 except that an aqueous solution of polyvinyl alcohol was coated using a size press machine so as to be 0.03 g/m² instead of 1 g/m² per one surface in terms of solids in Example 1.

### Comparative Example 3

Glass plate interleaving paper was obtained in the same manner as in Example 4 except that an organopolysiloxane-based defoaming agent (SN-DEFOAMER 503K manufactured by SAN NOPCO LIMITED) was used instead of a defoaming agent containing a polyether-based compound as a main component in Example 4.

### Comparative Example 4

Glass plate interleaving paper was obtained in the same manner as in Example 1 except that an aqueous resin of an acrylic resin emulsion (Ultrasol (registered trademark) UL-1026/acrylic acid ester-based copolymer resin manufactured by Aica Kogyo Co., Ltd.) was used instead of an aqueous solution of polyvinyl alcohol (EXCEVAL (registered trademark) RS-2817 SB manufactured by KURARAY CO., LTD.) in Example 1.

<Results for Measurement and Evaluation>

The results for measurement and evaluation in Examples 1 to 7 and Comparative Examples 1 to 4 are presented in Table 1. In the glass plate interleaving paper of Examples 1 to 7 according to the present invention, the contamination property of the surface of the glass plate was low. In Comparative Examples 1 to 4, the contamination property of the surface of the glass plate was high.

TABLE 1

| | Water-soluble resin | | | | Contamination | Contamination |
|---|---|---|---|---|---|---|
| | | Imparted | | Content of | property | property |
| | | amount | Solubility | organopolysiloxane | before water | after water |
| | Kind | (g/m²) | (%) | compound (mg/kg) | washing | washing |
| Example 1 | Polyvinyl alcohol | 2 | 65 | 0.3 | ◯ | ⊚ |
| Example 2 | Polyacrylamide | 2 | 93 | 0.3 | ◯ | ⊚ |
| Example 3 | Oxidized starch | 2 | 100 | 0.3 | ◯ | ◯ |
| Example 4 | Polyvinyl alcohol | 2 | 100 | 0.3 | ◯ | ⊚ |
| Example 5 | Polyvinyl alcohol | 1 | 65 | 0.3 | ◯ | ◯ |
| Example 6 | Polyvinyl | 2 | 95 | 1.0 | ◯ | ⊚ |
| | alcohol/polyacrylamide | | | | | |
| Example 7 | Polyvinyl alcohol | 2 | 55 | 0.3 | ◯ | ◯ |
| Comparative | — | 0 | — | 0.3 | X | X |
| Example 1 | | | | | | |
| Comparative | Polyvinyl alcohol | 0.06 | 65 | 0.3 | X | X |
| Example 2 | | | | | | |
| Comparative | Polyvinyl alcohol | 2 | 100 | 10 | X | X |
| Example 3 | | | | | | |
| Comparative | Acrylic acid ester | 2 | 0 | 0.3 | X | X |
| Example 4 | copolymer | | | | | |

<Effect of Invention>

According to the present invention, a water-soluble resin imparted to the paper base material can be contained in the glass plate interleaving paper in a state of covering at least a part of the components constituting the paper base material. At this time, the water-soluble resin may be present as a film covering the outer surface of the paper base material of the glass plate interleaving paper, may be present inside the paper base material, or may be present on the outer surface of and inside the paper base material. In the present invention, an effect of being able to decrease the opportunity that the components constituting the paper base material come into direct contact with the glass plate and of suppressing the transfer of foreign substances from the interleaving paper to the glass plate is exhibited as the water-soluble resin covers at least a part of the components constituting the paper base material in this manner. In addition, even in a case in which the water-soluble resin which contains or does not contain the components constituting the paper base material comes into contact with and adheres to the glass plate, an effect of being able to easily remove the adhered substances from the surface of the glass plate through cleaning using water is exhibited since a specific resin having a high solubility is selectively used as a water-soluble resin in the present invention.

1. Glass plate interleaving paper prepared by imparting a water-soluble resin to a paper base material containing cellulose pulp as a main component in an amount of 0.1 g/m² or more in terms of solids, wherein
in the case where a film is formed of the water-soluble resin and immersed in water at 40° C. for 1 hour, the water-soluble resin has a solubility of a film of 50% or more based on a mass of the film before being immersed, and
a content of an organopolysiloxane compound to be contained in 1 kg of air-dried mass of the glass plate interleaving paper is 5 mg or less.

2. The glass plate interleaving paper for according to claim 1, wherein an amount of the water-soluble resin imparted to the paper base material is 0.2 g/m² or more and 10 g/m² or less in terms of solids.

3. The glass plate interleaving paper according to claim 1, wherein in the case where a film is formed of the water-soluble resin and immersed in water at 40° C. for 1 hour, the water-soluble resin has a solubility of a film of 90% or more based on a mass of the film before being immersed.

4. The glass plate interleaving paper according to claim 1, wherein the water-soluble resin is at least one kind or a mixture of two or more kinds selected from the group consisting of a polyvinyl alcohol-based resin, a polyacrylamide-based resin, starch, and any modified product thereof.

5. The glass plate interleaving paper according to claim 1, wherein the water-soluble resin is polyvinyl alcohol having a saponification degree of from 70 to 97 mol %.

6. The glass plate interleaving paper according to claim 2, wherein in the case where a film is formed of the water-soluble resin and immersed in water at 40° C. for 1 hour, the water-soluble resin has a solubility of a film of 90% or more based on a mass of the film before being immersed.

7. The glass plate interleaving paper according to claim 2, wherein the water-soluble resin is at least one kind or a mixture of two or more kinds selected from the group consisting of a polyvinyl alcohol-based resin, a polyacrylamide-based resin, starch, and any modified product thereof.

8. The glass plate interleaving paper according to claim 3, wherein the water-soluble resin is at least one kind or a mixture of two or more kinds selected from the group consisting of a polyvinyl alcohol-based resin, a polyacrylamide-based resin, starch, and any modified product thereof.

9. The glass plate interleaving paper according to claim 2, wherein the water-soluble resin is polyvinyl alcohol having a saponification degree of from 70 to 97 mol %.
